(19) United States
(12) Patent Application Publication
(10) Pub. No.: US 2016/0086633 A1
(43) Pub. Date: Mar. 24, 2016

(54) Combine Audio Signals to Animated Images

(71) Applicant: Nokia Technologies Oy, Espoo (FI)

(72) Inventors: Jussi Kalevi Virolainen, Espoo (FI); Aleksi Eeben, Espoo (FI)

(73) Assignee: Nokia Technologies Oy, Espoo (FI)

(21) Appl. No.: 14/783,031

(22) PCT Filed: Apr. 10, 2013
(86) PCT No.: PCT/IB2013/052854

§ 371 Date: Oct. 7, 2015

(51) Int. Cl. G11B 27/036; H04N 21/462; H04N 21/422; H04N 21/439; G11B 27/10; H04N 21/81

(52) U.S. Cl. CPC G11B 27/036; G11B 27/105; H04N 21/816; H04N 21/42202; H04N 21/4394; H04N 21/4622; H04N 21/8153

(57) ABSTRACT

An apparatus comprising: an input configured to receive at feast one audio signal and/or sensor signal; an image input configured to receive at least one image frame; a context determiner configured to determine at least one context based on the at least one audio signal and/or sensor signal; an audio track suggestion determiner configured to determine at least one context audio signal based on the at least one context; and a mixer configured to associate the at least one context audio signal with the at least one image frame.

### FIELD

The present invention relates to a providing additional functionality for images. The invention further relates to, but is not limited to, display apparatus providing additional functionality for images displayed in mobile devices.

### BACKGROUND

Many portable devices, for example mobile telephones, are equipped with a display such as a glass or plastic display window for providing information to the user. Furthermore such display windows are now commonly used as touch sensitive inputs. In some further devices the device is equipped with transducers suitable for generating audible feedback.

Images and animated images are known. Animated images or cinemagraph images can provide the illusion that the viewer is watching a video. The cinemagraph are typically still photographs in which a minor and repeated movement occurs. These are particularly useful as they can be transferred or transmitted between devices using significantly smaller bandwidth than conventional video.

### STATEMENT

According to an aspect, there is provided a method comprising: receiving at least one audio signal and/or sensor signal; receiving at least one image frame; determining at least one context based on the at least one audio signal and/or sensor signal; determining at least one context audio signal based on the at least one context; and associating the at least one context audio signal with the at least one image frame.

Receiving at least one sensor signal may comprise at least one of: receiving a humidity value from a humidity sensor; receiving a temperature value from a thermometer sensor; receiving a position estimate from a position estimating sensor; receiving an orientation estimate from a compass; receiving an illumination value from an illumination sensor receiving the at least one image frame from a camera sensor, receiving an air pressure value from an air pressure sensor; receiving the at least one sensor signal from a memory; and receiving the at least one sensor signal from an external apparatus.

Determining at least one context audio signal associated with the at least one audio context may comprise: determining at least one library audio signal, wherein the at least one library audio signal comprises a context value; and selecting the at least one context audio signal from the at least one library audio signal and the at least one audio signal.

Selecting the at least one context audio signal from the at least one library audio signal and the at least one audio signal may comprise selecting the at least one context audio signal from the at least one library audio signal based on the context value similarity to the at least one context.

Selecting the at least one context audio signal from the at least one library audio signal based on the context value similarity to the at least one context determined by analysing the at least one audio signal may comprise: displaying the at least one library audio signal in an order based on the at least one library signal context value similarity to the at least one context; and receiving at least one user interface selection from the displayed at least one library audio signal.

Determining at least one context audio signal associated with the at least one context may further comprise mixing the at least one context audio signal from the selected at least one library audio signal and the at least one audio signal.

Determining at least one library audio signal comprising a context value may comprise at least one of: receiving at least one library audio signal from a memory audio track library; and receiving at least one library audio signal from an external server audio track library.

The method may further comprise generating at least one animated image from the at least one image frame and associating the at least one context audio with at least part of the at least one animated image.

Receiving at least one audio signal may comprise at least one of: receiving the at least one audio signal from at least one microphone; receiving the at least one audio signal from a memory; and receiving the at least one audio signal from an external apparatus.

Receiving the at least one image frame may comprise: receiving the at least one image frame from at least one camera; receiving the at least one image frame from a memory; receiving the at least one image frame from a video recording; receiving the at least one image frame from a video file; and receiving the at least one image frame from an external apparatus.

According to a second aspect there is provided an apparatus comprising: means for receiving at least one audio signal and/or sensor signal; means for receiving at least one image frame; means for determining at least one context based on the at least one audio signal and/or sensor signal; means for determining at least one context audio signal based on the at least one context; and means for associating the at least one context audio signal with the at least one image frame.

The means for receiving at least one sensor signal may comprise at least one of: means for receiving a humidity value from a humidity sensor; means for receiving a temperature value from a thermometer sensor; means for receiving a position estimate from a position estimating sensor; means for receiving an orientation estimate from a compass; means for receiving an illumination value from an illumination sensor means for receiving the at least one image frame from a camera sensor; means for receiving an air pressure value from an air pressure sensor, means for receiving the at least one sensor signal from a memory; and means for receiving the at least one sensor signal from an external apparatus.

The means for determining at least one context audio signal associated with the at least one audio context may comprise: means for determining at least one library audio signal, wherein the at least one library audio signal comprises a context value; and means for selecting the at least one context audio signal from the at least one library audio signal and the at least one audio signal.

The means for selecting the at least one context audio signal from the at least one library audio signal and the at least one audio signal may comprise: means for selecting the at least one context audio signal from the at least one library audio signal based on the context value similarity to the at least one context.

The means for selecting the at least one context audio signal from the at least one library audio signal based on the context value similarity to the at least one context determined by analysing the at least one audio signal may comprise: means for displaying the at least one library audio signal in an order based on the at least one library signal context value similarity to the at least one context; and means for receiving at least one user interface selection from the displayed at least one library audio signal.

The means for determining at least one context audio signal associated with the at least one context may further comprise means for mixing the at least one context audio signal from the selected at least one library audio signal and the at least one audio signal.

The means for determining at least one library audio signal comprising a context value may comprise at least one of: means for receiving at least one library audio signal from a memory audio track library; and means for receiving at least one library audio signal from an external server audio track library.

The apparatus may further comprise means for generating at least one animated image from the at least one image frame and associating the at least one context audio with at least part of the at least one animated image.

The means for receiving at least one audio signal may comprise at least one of: means for receiving the at least one audio signal from at least one microphone; means for receiving the at least one audio signal from a memory; and means for receiving the at least one audio signal from an external apparatus.

The means for receiving the at least one image frame may comprise at least one of: means for receiving the at least one image frame from at least one camera; means for receiving the at least one image frame from a memory; means for receiving the at least one image frame from a video recording; means for receiving the at least one image frame from a video file; and means for receiving the at least one image frame from an external apparatus.

According to a third aspect there is provided an apparatus comprising at least one processor and at least one memory including computer code for one or more programs, the at least one memory and the computer code configured to with the at least one processor cause the apparatus to at least: receive at least one audio signal and/or sensor signal; receive at least one image frame; determine at least one context based on the at least one audio signal and/or sensor signal; determine at least one context audio signal based on the at least one context; and associate the at least one context audio signal with the at least one image frame.

Receiving at least one sensor signal may cause the apparatus to perform at least one of: receive a humidity value from a humidity sensor; receive a temperature value from a thermometer sensor; receive a position estimate from a position estimating sensor; receive an orientation estimate from a compass; receive an illumination value from an illumination sensor; receive the at least one image frame from a camera sensor, receive an air pressure value from an air pressure sensor, receive the at least one sensor signal from a memory; and receive the at least one sensor signal from an external apparatus.

Determining at least one context audio signal associated with the at least one audio context may cause the apparatus to: determine at least one library audio signal, wherein the at least one library audio signal comprises a context value; and select the at least one context audio signal from the at least one library audio signal and the at least one audio signal.

Selecting the at least one context audio signal from the at least one library audio signal and the at least one audio signal may cause the apparatus to: select the at least one context audio signal from the at least one library audio signal based on the context value similarity to the at least one context.

Selecting the at least one context audio signal from the at least one library audio signal based on the context value similarity to the at least one context determined by analysing the at least one audio signal may cause the apparatus to: display the at least one library audio signal in an order based on the at least one library signal context value similarity to the at least one context; and receiving at least one user interface selection from the displayed at least one library audio signal.

Determining at least one context audio signal associated with the at least one context further may cause the apparatus to mix the at least one context audio signal from the selected at least one library audio signal and the at least one audio signal.

Determining at least one library audio signal comprising a context value may cause the apparatus to: receive at least one library audio signal from a memory audio track library; and receive at least one library audio signal from an external server audio track library.

The apparatus may further be caused to generate at least one animated image from the at least one image frame and associate the at least one context audio with at least part of the at least one animated image.

Receiving at least one audio signal may cause the apparatus to perform at least one of: receive the at least one audio signal from at least one microphone; receive the at least one audio signal from a memory; and receive the at least one audio signal from an external apparatus.

Receiving the at least one image frame may cause the apparatus to perform at least one of: receive the at least one image frame from at least one camera; receive the at least one image frame from a memory; receive the at least one image frame from a video recording; receive the at least one image frame from a video file and receive the at least one image frame from an external apparatus.

According to a fourth aspect there is provided an apparatus comprising: an input configured to receive at least one audio signal and/or sensor signal; an image input configured to receive at least one image frame; a context determiner configured to determine at least one context based on the at least one audio signal and/or sensor signal; an audio track suggestion determiner configured to determine at least one context audio signal based on the at least one context; and a mixer configured to associate the at least one context audio signal with the at least one image frame.

The at least one sensor signal may comprise at least one of: a humidity value from a humidity sensor; a temperature value from a thermometer sensor; a location estimate from a location estimating sensor; an orientation estimate from a compass; an illumination value from an illumination sensor; at least one image frame from a camera sensor; an air pressure value from an air pressure sensor; at least one sensor signal from a memory; and at least one sensor signal from an external apparatus.

The audio track suggestion determiner may be configured to: determine at least one library audio signal, wherein the at least one library audio signal comprises a context value; and select the at least one context audio signal from the at least one library audio signal and the at least one audio signal.

The audio track suggestion determiner may be configured to: selecting the at least one context audio signal from the at least one library audio signal based on the context value similarity to the at least one context determined by the context determiner.

The audio track suggestion determiner may be configured to: displaying the at least one library audio signal in an order based on the at least one library signal context value similarity to the at least one context determined by the context determiner; and receive at least one user interface selection from the displayed at least one library audio signal.

The audio track suggestion determiner may further comprise a mixer configured to mix the at least one context audio signal from the selected at least one library audio signal and the at least one audio signal.

The audio track suggestion determiner may comprise at least one of: an input configured to receive at least one library audio signal from a memory audio track library; and an input configured to receive at least one library audio signal from an external server audio track library.

The apparatus may further comprise a cinemagraph generator configured to generate at least one animated image from the at least one image frame and associate the at least one context audio with at least part of the at least one animated image.

The input may be configured to receive the at least one audio signal from at least one microphone

The input may be configured to receive the at least one audio signal from a memory.

The input may be configured to receive the at least one audio signal from an external apparatus.

The image input may be configured to receive the at least one image frame from at least one camera.

The image input may be configured to receive the at least one image frame from a memory.

The image input may be configured to receive the at least one image frame from a video recording.

The image input may be configured to receive the at least one image frame from a video file.

The image input may be configured to receive the at least one image frame from an external apparatus.

An apparatus may be configured to perform the method as described herein.

A computer program product comprising program instructions may cause an apparatus to perform the method as described herein.

An electronic device may comprise apparatus as described herein.

A chipset may comprise apparatus as described herein.

### SUMMARY OF FIGURES

For better understanding of the present invention, reference will now be made by way of example to the accompanying drawings in which:

FIG. 1 shows schematically an apparatus suitable for employing some embodiments;

FIG. 2 shows schematically an example audio enhanced cinemagraph generator; FIG. 3 shows a flow diagram of the operation of the audio enhanced cinemagraph generator as shown in FIG. 2 according to some embodiments;

FIG. 4 shows a further flow diagram of the operation of the audio track suggestion determiner and audio track generator as shown in FIG. 2 according to some embodiments;

FIG. 5 shows a schematic view of example user interface display according to some embodiments;

FIG. 6 shows a schematic view of a further example user interface display according to some embodiments; and

FIG. 7 shows a schematic view of a further example user interface track listing according to some embodiments.

### DESCRIPTION OF EXAMPLE EMBODIMENTS

The concept of embodiments of the application is to combine audio signals to cinemagraphs (animated images) during the generation of cinemagraphs or animated images or post-processing of cinemagraphs after creation. For example it would be understood that a user may compose a cinemagraph, but decides to improve the audio at a later time using the embodiments as described herein.

Image capture and enhancement or processing is a largely subjective decision. For example although filter effects are commonly fairly easy to apply, using and combining them in a way that complements rather than distracts from the subject matter is an acquired skill. An image capture and processing system which employs effects which are more effective for the average user appears to require settings of parameters used in the processing which are to some degree context-aware.

Cinemagraphs or animated images are seen as an extension of a photograph and produced using postproduction techniques. The cinemagraph provides a means to enable motion of an object common between images or in a region of an otherwise still or static picture. For example the design or aesthetic element allows subtle motion elements while the rest of the image is still. In some cinemagraphs the motion or animation feature is repeated. In the following description and claims the term object, common object, or subject can be considered to refer to any element, object or component which is shared (or mutual) across the images used to create the cinemagraph or animated object. For example the images used as an input could be a video of a moving toy train against a substantially static background. In such an example the object, subject, common object, region, or element can be the toy train which in the animated image provides the dynamic or subtle motion element whilst the rest of the image is still. It would be understood that whether the object or subject is common does not necessitate that the object, subject, or element is substantially identical from frame to frame. However typically there is a large degree of correlation between subsequent image objects as the object moves or appears to move. For example the object or subject of the toy train can appear to move to and from the observer from frame to frame in such a way that the train appears to get larger/smaller or the toy train appears to turn away from or to the observer by the toy train profile changing.

The size, shape and position of the position of interest or in other words the region of the image identified as the subject, object or element can change from image to image, however within the image is a selected entity which from frame to frame has a degree of correlation (as compared to the static image components which have substantially perfect correlation from frame to frame).

An issue or problem is the addition of audio to the animation element within the cinemagraph. Although it has been proposed that recorded or captured audio can be combined with the image, the quality of the audio content recorded by user may be quite low or aesthetically unsuitable. For example audio signals captured from a real café, may not sound pleasant at all. Also where the recorded or captured audio contains understandable speech, looping this kind of track may be very disturbing to the listener.

Editing of the recording itself may result in problems. Automatic selection of a looping point for the recorded audio may result in audible artifacts as the loop passes from the end of the loop to the start of the next loop. It would be understood that the video or animated image within a cinemagraph is cycled or loopable and therefore the audio track chosen should be able to be cycled or loopable too.

Furthermore another possibility, that of selecting a suitable pre-composed or pre-recorded audio track from a library of pre-composed or pre-recorded tracks may provide excellent aesthetic quality (for example a pre-recorded and edited ambient café sound may sound very pleasant when it is designed or selected by a sound designer with a good quality looping point). However, the use of predefined or pre-recorded audio track can be problematic for the user where the number of possible audio tracks in the library is high.

The concept in some embodiments is therefore to implement an audio context recognition or determination to detect the acoustic context (“quiet”, “conversation”, “vehicle” etc.) when recording or capturing a video in order to make a cinemagraph. The detected context can then be used to generate and select contextually similar audio tracks. For example in some embodiments the detected context is used to automatically suggest similar pre-composed or pre-recorded audio tracks from an audio library, from which an audio track can be selected. For example, the context determiner can detect that the recorded audio has a “vehicle” context and suggested audio tracks of “Car”, “Train” or “Metro”. From these suggestions a user may select quickly an aesthetically pleasant pre-composed or pre-recorded audio track for the cinemagraph. One benefit of employing the embodiments as described herein is to be able to use large audio track databases. The audio track databases could even contain different alternatives of similar contexts such as “noisy café” or “peaceful café”.

In some embodiments as described in further detail herein the audio track for the cinemagraph can be created from selecting one of or a combination of the recorded audio signal, the library pre-composed or pre-recorded loopable ambient sound track or a context sorted music track.

In the following examples it would be understood that ambient cinemagraph picture/video loops are usually short loops of about 1-10 seconds. Other audio track loops can be implemented as described herein but require in some embodiments loop length to be longer about 10-60 seconds, to prevent repetitiveness which sounds uncomfortable for the user.

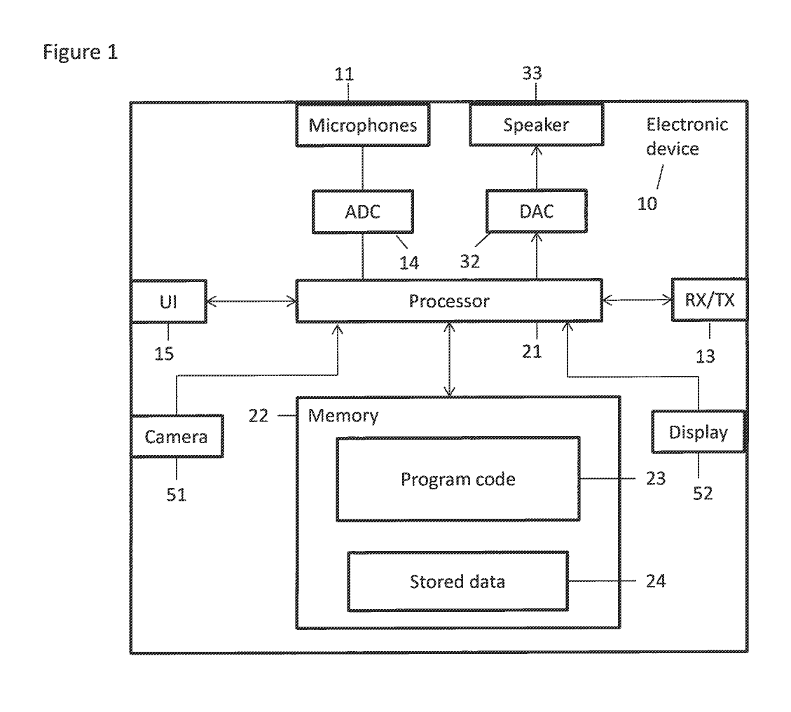

With respect to FIG. 1 a schematic block diagram of an example electronic device 10 or apparatus on which embodiments of the application can be implemented. The apparatus 10 is such embodiments configured to provide improved image experiences.

The apparatus 10 is in some embodiments a mobile terminal, mobile phone or user equipment for operation in a wireless communication system. In other embodiments, the apparatus is any suitable electronic device configured to process video and audio data. In some embodiments the apparatus is configured to provide an image display, such as for example a digital camera, a portable audio player (mp3 player), a portable video player (mp4 player). In other embodiments the apparatus can be any suitable electronic device with touch interface (which may or may not display information) such as a touch-screen or touch-pad configured to provide feedback when the touch-screen or touch-pad is touched. For example in some embodiments the touch-pad can be a touch-sensitive keypad which can in some embodiments have no markings on it and in other embodiments have physical markings or designations on the front window. The user can in such embodiments be notified of where to touch by a physical identifier—such as a raised profile, or a printed layer which can be illuminated by a light guide.

The apparatus 10 comprises a touch input module 15 or in some embodiments any suitable user interface (UI), which is linked to a processor 21. The processor 21 is further linked to a display 52. The processor 21 is further linked to a transceiver (TX/RX) 13 and to a memory 22.

In some embodiments, the touch input module (or user interface) 15 and/or the display 52 are separate or separable from the electronic device and the processor receives signals from the touch input module (or user interface) 15 and/or transmits and signals to the display 52 via the transceiver 13 or another suitable interface. Furthermore in some embodiments the touch input module (or user interface) 15 and display 52 are parts of the same component. In such embodiments the touch interface module (or user interface) 15 and display 52 can be referred to as the display part or touch display part.

The processor 21 can in some embodiments be configured to execute various program codes. The implemented program codes, in some embodiments can comprise such routines as audio signal analysis and audio signal processing, image analysis, touch processing, gaze or eye tracking. The implemented program codes can in some embodiments be stored for example in the memory 22 and specifically within a program code section 23 of the memory 22 for retrieval by the processor 21 whenever needed. The memory 22 in some embodiments can further provide a section 24 for storing data, for example data that has been processed in accordance with the application, for example audio signal data.

The touch input module (or user interface) 15 can in some embodiments implement any suitable touch screen interface technology. For example in some embodiments the touch screen interface can comprise a capacitive sensor configured to be sensitive to the presence of a finger above or on the touch screen interface. The capacitive sensor can comprise an insulator (for example glass or plastic), coated with a transparent conductor (for example indium tin oxide—ITO). As the human body is also a conductor, touching the surface of the screen results in a distortion of the local electrostatic field, measurable as a change in capacitance. Any suitable technology may be used to determine the location of the touch. The location can be passed to the processor which may calculate how the user's touch relates to the device. The insulator protects the conductive layer from dirt, dust or residue from the finger.

In some other embodiments the touch input module (or user interface) can be a resistive sensor comprising of several layers of which two are thin, metallic, electrically conductive layers separated by a narrow gap. When an object, such as a finger, presses down on a point on the panel's outer surface the two metallic layers become connected at that point: the panel then behaves as a pair of voltage dividers with connected outputs. This physical change therefore causes a change in the electrical current which is registered as a touch event and sent to the processor for processing.

In some other embodiments the touch input module (or user interface) can further determine a touch using technologies such as visual detection for example a camera either located below the surface or over the surface detecting the position of the finger or touching object, projected capacitance detection, infra-red detection, surface acoustic wave detection, dispersive signal technology, and acoustic pulse recognition. In some embodiments it would be understood that ‘touch’ can be defined by both physical contact and ‘hover touch’ where there is no physical contact with the sensor but the object located in close proximity with the sensor has an effect on the sensor.

The touch input module as described here is an example of a user interface 15. It would be understood that in some other embodiments any other suitable user interface input can be employed to provide an user interface input, for example to select an item, object, or region from a displayed screen. In some embodiments the user interface input can thus be a keyboard, mouse, keypad, joystick or any suitable pointer device.

The apparatus 10 can in some embodiments be capable of implementing the processing techniques at least partially in hardware, in other words the processing carded out by the processor 21 may be implemented at least partially in hardware without the need of software or firmware to operate the hardware.

The transceiver 13 in some embodiments enables communication with other electronic devices, for example in some embodiments via a wireless communication network.

The display 52 may comprise any suitable display technology. For example the display element can be located below the touch input module (or user interface) and project an image through the touch input module to be viewed by the user. The display 52 can employ any suitable display technology such as liquid crystal display (LCD), light emitting diodes (LED), organic light emitting diodes (OLED), plasma display cells, Field emission display (FED), surface-conduction electron-emitter displays (SED), and Electrophoretic displays (also known as electronic paper, e-paper or electronic ink displays). In some embodiments the display 12 employs one of the display technologies projected using a light guide to the display window.

The apparatus 10 can in some embodiments comprise an audio-video subsystem. The audio-video subsystem for example can comprise in some embodiments a microphone or array of microphones 11 for audio signal capture. In some embodiments the microphone or array of microphones can be a solid state microphone, in other words capable of capturing audio signals and outputting a suitable digital format signal. In some other embodiments the microphone or array of microphones 11 can comprise any suitable microphone or audio capture means, for example a condenser microphone, capacitor microphone, electrostatic microphone, Electret condenser microphone, dynamic microphone, ribbon microphone, carbon microphone, piezoelectric microphone, or micro electrical-mechanical system (MEMS) microphone. In some embodiments the microphone 11 is a digital microphone array, in other words configured to generate a digital signal output (and thus not requiring an analogue-to-digital converter). The microphone 11 or array of microphones can in some embodiments output the audio captured signal to an analogue-to-digital converter (ADC) 14.

In some embodiments the apparatus can further comprise an analogue-to-digital converter (ADC) 14 configured to receive the analogue captured audio signal from the microphones and outputting the audio captured signal in a suitable digital form. The analogue-to-digital converter 14 can be any suitable analogue-to-digital conversion or processing means. In some embodiments the microphones are ‘integrated’ microphones containing both audio signal generating and analogue-to-digital conversion capability.

In some embodiments the apparatus 10 audio-video subsystem further comprises a digital-to-analogue converter 32 for converting digital audio signals from a processor 21 to a suitable analogue format. The digital-to-analogue converter (DAC) or signal processing means 32 can in some embodiments be any suitable DAC technology.

Furthermore the audio-video subsystem can comprise in some embodiments a speaker 33. The speaker 33 can in some embodiments receive the output from the digital-to-analogue converter 32 and present the analogue audio signal to the user. In some embodiments the speaker 33 can be representative of multi-speaker arrangement, a headset, for example a set of headphones, or cordless headphones. The speaker in some embodiments can thus be representative as any suitable audio output means.

In some embodiments the apparatus audio-video subsystem comprises at least one camera 51 or image capturing means configured to supply to the processor 21 image data. In some embodiments the camera can be configured to supply multiple images over time to provide a video stream.

In some embodiments the apparatus comprises a position sensor configured to estimate the position or location of the apparatus 10. The position sensor can in some embodiments be a satellite positioning sensor such as a GPS (Global Positioning System), GLONASS or Galileo receiver.

In some embodiments the positioning sensor can be a cellular ID system or an assisted GPS system.

In some embodiments the apparatus 10 further comprises a direction or orientation sensor. The orientation/direction sensor can in some embodiments be an electronic compass, accelerometer, and a gyroscope or be determined by the motion of the apparatus using the positioning estimate.

It is to be understood again that the structure of the electronic device 10 could be supplemented and varied in many ways.

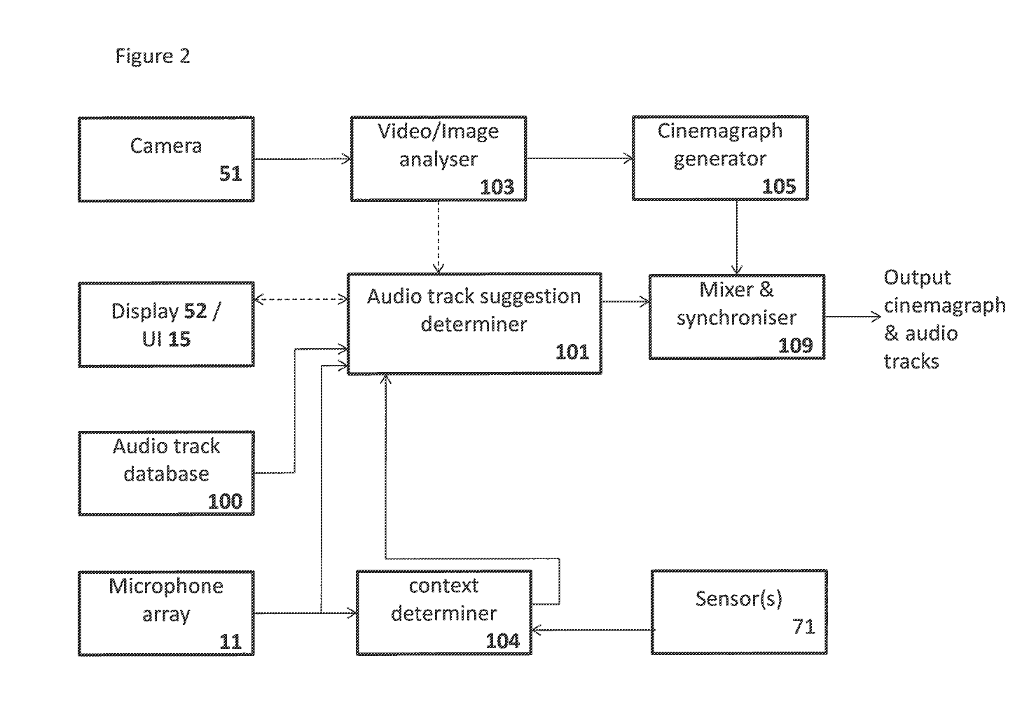

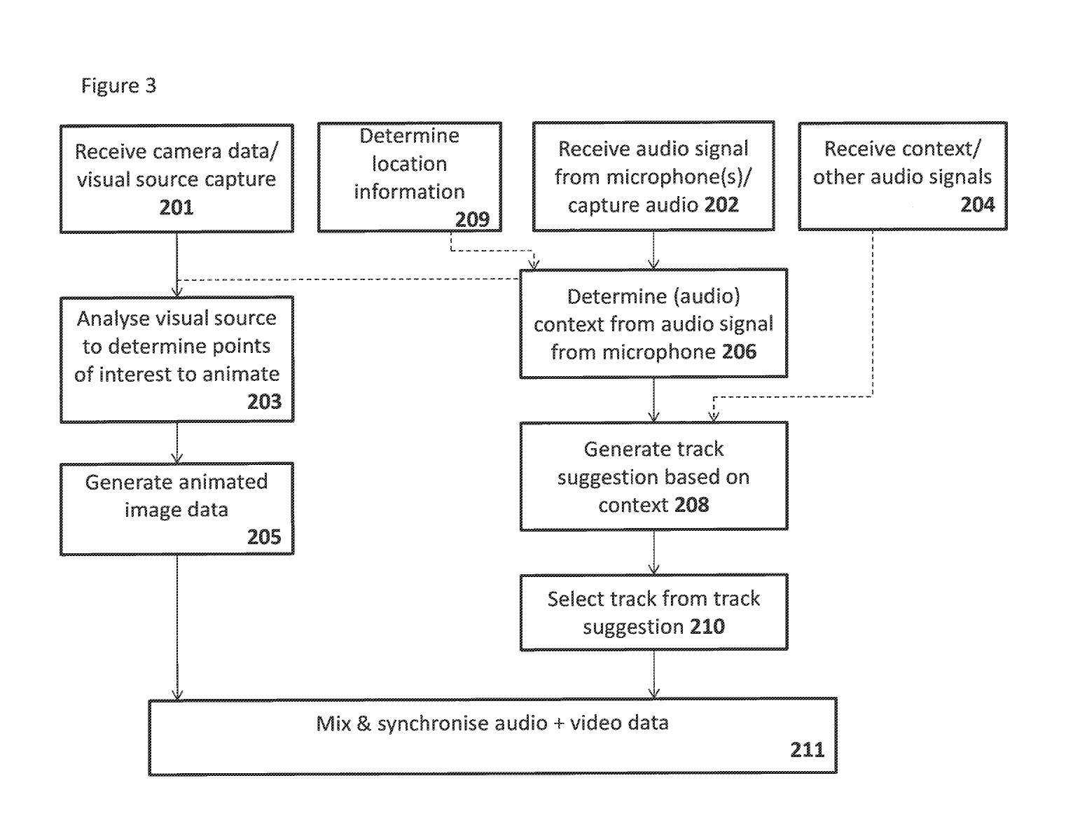

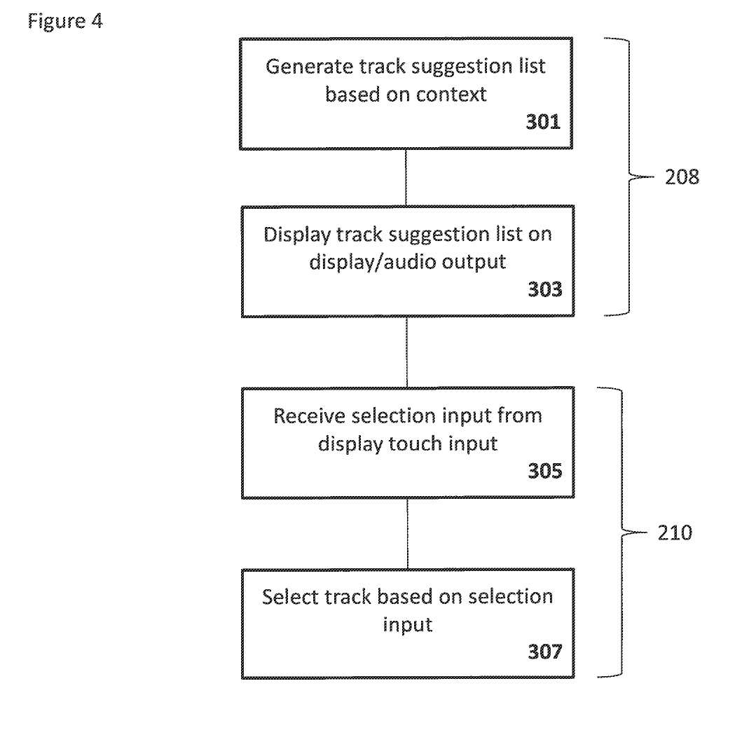

With respect to FIG. 2 an example audio enhanced cinemagraph generator is shown. Furthermore with respect to FIGS. 3 and 4 the operation of the example audio enhanced cinemagraph generator as shown in FIG. 2 is further described. Although the following examples are described with respect to animated images it would be understood that in some embodiments the embodiments as described herein can be applied to purely static images. For example an audio signal can be associated with a single image frame based on the at least one context associated with the audio signal being recorded about the time the image was captured.

In some embodiments the audio enhanced cinemagraph generator comprises a camera 51. The camera 51 or means for capturing images can be any suitable video or image capturing apparatus. The camera 51 can be configured to capture images that the user of the apparatus wishes to process and pass the image or video data to a video/image analyser 103.

The operation of capturing or receiving video or images from the camera is shown in FIG. 3 by step 201.

It would be appreciated that the described embodiments feature ‘live’ capture of images or image frames by an apparatus comprising the camera, that in some embodiments the camera is located on an external apparatus to the apparatus performing the embodiments as described herein, in other words the apparatus receives the images from the camera either located on the apparatus or external to the apparatus. Furthermore it would be understood that in some embodiments the apparatus is configured to feature ‘editing’ operations, in other words the image frames are received either from a memory, such as a mass memory device on the apparatus, or received from an external apparatus such as an image frame capture server.

In some embodiments the audio enhanced cinemagraph generator comprises the microphone or microphone array 11. The array of microphones 11 are configured to record or capture audio signals from different locations. The audio signals from the microphone array 11 can in some embodiments be passed to a context determiner 104 and an audio track suggestion determiner 101.

The operation of capturing or receiving audio signals from the microphones is shown in FIG. 3 by step 202.

Similar to the receiving of the image frames it would be appreciated that the described embodiments feature ‘live’ capture of audio signals by an apparatus comprising the at least one microphones. Furthermore in some embodiments the at least one of the microphones are located on an external apparatus to the apparatus performing the embodiments as described herein, in other words the apparatus receives the audio signals from microphones either located on the apparatus or external to the apparatus. Furthermore it would be understood that in some embodiments the apparatus is configured to feature ‘editing’ operations, in other words the audio signals are received or retrieved either from a memory, such as a mass memory device on the apparatus, or received from an external apparatus such as an audio capture server.

In some embodiments the audio enhanced cinemagraph generator comprises a context determiner 104 configured to receive the audio signals from the microphone array and/or other sensor(s) and analyse the audio signals and/or other sensor(s) to determine a context.

The context determiner 104 or means for determining a context can be any suitable classifier configured to output a context ‘classification’ based on feature analysis that is performed for the audio signals and/or other sensor(s) signals.

In some embodiments therefore the context determiner 104 comprises an audio context determiner configured to receive the at least one audio signals (such as from the microphones (for live editing) and/or memory (for recorded or off line editing) and determine a suitable context based on the audio signals. The audio context determiner can in some embodiments therefore be any suitable classifier configured to output a context ‘classification’ based on feature analysis that is performed for the audio signals.

The context or classification can in some embodiments be a geographical ‘context’ or ‘classification’ defining an area or location such as ‘Airport’, ‘café’, ‘Factory’, ‘Marketplace’, ‘Night club’, ‘Office’. In some embodiments the context or classification can be event ‘context’ or ‘classification’ defining an act or event within which the user of the apparatus is attempting to capture such as ‘Applause’, Conversation’. Furthermore in some embodiments the context or classification can be a general environment or ambience surrounding the user of the apparatus such as ‘Nature’, ‘Ocean’, ‘Rain’, ‘Traffic’, ‘Train’, ‘Wind’.

The operation of determining a context or classification from the audio signal from the microphone is shown in FIG. 3 by step 206.

In some embodiments the context determiner 104 can comprise a sensor signal context determiner and be configured to generate a context or classification based on sensor signals from at least one other sensor (or in some embodiments recorded sensor signals from a memory or suitable storage means). In the example shown in FIG. 3 the sensor(s) are shown by the box sensor(s) 71.

For example in some embodiments the sensor(s) 71 can comprise a suitable location/position/orientation estimation sensor or receiver.

In such embodiments the context determiner 104 can then determine from the location/position/orientation estimation of the apparatus information whether the apparatus is located within a defined context or classification location. In some embodiments the context determiner may interact with location database services, e.g. Nokia Here which stores geographical location context classes. It would be understood that in some embodiments the location may not need to be defined as exact geographical location in other words in some embodiments the location can refer to a type of location within which the apparatus is located.

Furthermore in some embodiments the sensor(s) 71 can be any suitable sensor generating sensor signal information which can be used either alone or associated with the other information to determine the context. For example in some embodiments the sensor 71 comprises a humidity sensor, and the audio context determiner (or context determiner or means for determining a context) can be configured to receive a humidity value and from the value determine a humidity based context or class.

In some embodiments the sensor 71 can comprise a thermometer and the context determiner configured to receive a temperature value and from the value determine a temperature based context or class. In some embodiments the sensor 71 can comprise an illumination sensor, such as a photodiode or similar and the context determiner configured to receive an illumination value and from the value determine an illumination based context or class. In some embodiments the sensor 71 comprises a pressure sensor and the context determiner configured to receive an air pressure value and from the value determine a pressure based context or class.

In some embodiments the context determiner can further be configured to receive the at least one image frame from the camera. In other words receive the camera data as a further sensor. In such embodiments the context determiner can be configured to analyse the image and determine a context based at least partially on the image. In some embodiments the context determiner comprises an object detector or object recognizer from which a context or list of contexts can be determined. For example where the camera image shows a car then the context determiner can be configured to determine that a suitable context is ‘car’ and suggest a potential library track. In some embodiments types of objects can be recognized and contexts associated with a type of object are determined. For example an image of a Lotus Elise can be analysed to determine a ‘Lotus Elise’ context, an image of an Aston Martin DB9 can be analysed to determine a ‘Aston Martin DB9’ context which can in some embodiments be sub-sets of the car context.

The optional operation of determining location information is shown in FIG. 3 by step 200.

For example the audio context determiner 104 can then in some embodiments be configured to determine from the audio analysis and the location/positional analysis that the apparatus is located within a café and thus generate a ‘café’ context result.

Similarly in some embodiments the audio context determiner 104 can be configured to receive images from the camera and determine the apparatus is capturing images with a defined context or classification. For example the audio context determiner 104 can be configured to determine from the audio analysis and the image analysis that the apparatus is located within a café and thus generate a ‘café’ context result.

The audio context value generated can in some embodiments be passed to the audio track suggestion determiner 101.

In some embodiments the apparatus comprises an audio track suggestion determiner 101. The audio track suggestion determiner 101 in some embodiments can be configured to receive an audio context or classification value from the audio context determiner 104.

Furthermore in some embodiments the audio track suggestion determiner 101 can be configured to receive an indication from an audio track database 100 of which audio tracks are available in the audio track database 100.

The operation of receiving context based audio signals is shown in FIG. 3 by step 204.

In some embodiments the apparatus comprises an audio track database 100 or library. The audio track database 100 in some embodiments comprises a database or store of pre-recorded or pre-composed audio tracks which are suitable audio tracks to be incorporated within an animated image or cinemagraph. In some embodiments each of the audio tracks are associated with a defined ‘context’ or classification. In some embodiments the context or classification list is similar to the context or classifications which are generated by the audio context determiner. In some embodiments the audio track can be associated with more than one context or classification. For example an audio track or people talking within a café can have associated context or classifications of both ‘conversation’ and ‘café’. In some embodiments the audio track database 100 comprises both the indication or association information and the audio track, however it would be understood that in some embodiments the audio track database 100 comprises the association information and a link to a location or address where the audio track is stored. In some embodiments, such as described herein, the audio track database 100 is stored on the apparatus, however it would be understood that in some embodiments the audio track database 100 is located remote from the apparatus. For example in some embodiments the audio track database 100 is a server configured to supply the apparatus with the association information and/or the audio track.

The audio track database or library can in some embodiments use a ‘cloud’ service which downloads the selected track to the device. In some embodiments where the cinemagraph application is a cloud based service, the audio library can exist in the back-end server providing the cinemagraph service. In some embodiments detected or determined context info is sent to a cloud service which starts to download best matching tracks to the device already before user has made a selection. This for example can minimize a waiting time.

In some embodiments the audio track suggestion determiner 101 can be configured to generate an audio track suggestion based on the received context determination.

The operation of generating a track suggestion based on the context determination is shown in FIG. 3 by step 208.

In some embodiments the audio track suggestion determiner 101 can be configured to generate a list of the available audio tracks from the audio track database 100.

In some embodiments this can be a list of all of the available tracks in the audio track database or library.

The operation of generating a track suggestion list based on the context determination is shown in FIG. 4 by step 301.

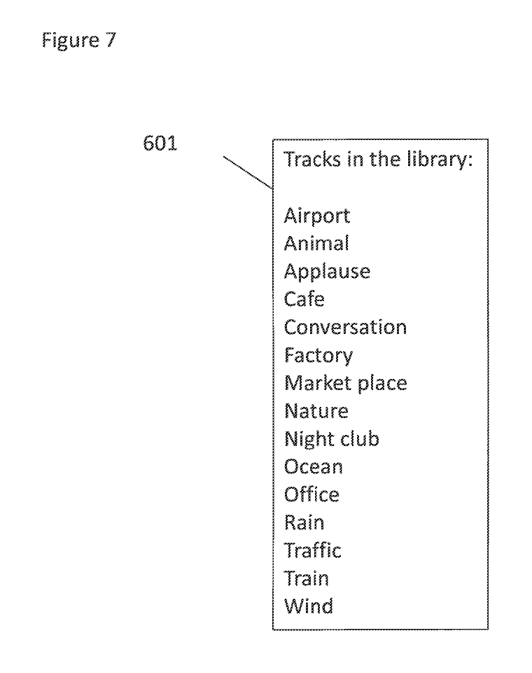

For example FIG. 7 shows an example track list 601 of all of the available tracks defined in terms of their associated context.

In some embodiments this list can be displayed on the display 52. In other words in some embodiments the apparatus can be configured to display the at least one library audio signal as part of selecting the at least one context audio signal from the at least one library signal based on the context value similarity.

The operation of displaying the track suggestion list based is shown in FIG. 4 by step 303.

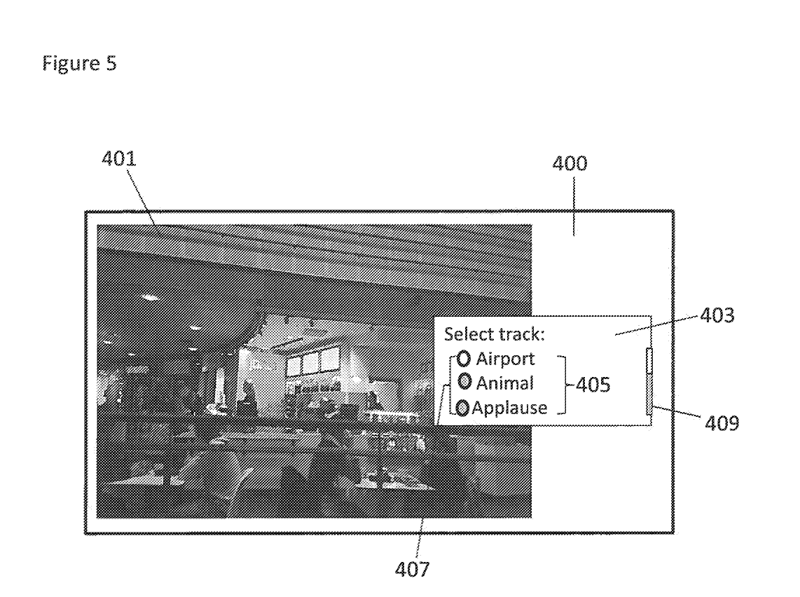

For example with respect to FIG. 5 an example user interface display output 400 is shown suitable for implementing embodiments as described herein. The display can for example in some embodiments be configured to show the image output 401 from the camera, (or the captured video/cinemagraph) and also a text/selection box 403 within which is shown a selection of the track suggestion list 405, a scroll bar 409 showing the position of the selection of the track suggestion list with respect to the full suggestion list and a selection radio button array 407 where at least one of the tracks are highlighted.

In some embodiments the audio track suggestion determiner 101 can be configured to order the list or highlight the list according to the context value generated by the audio context determiner 104. For example the audio track suggestion determiner 101 can be configured to order the list so that the tracks with contexts which are the same as or ‘similar’ to the determined context are at the top of the list.

In some embodiments, the audio track suggestion determiner may at least one generate list where some of the items at the top of the list are determined based only on audio context and same based only on location context. For example this allows the audio track suggestion determiner to suggest “Café” audio track always when the user is physically located in a café according to location context. These embodiments can be beneficial where the captured sound scene in the café is far from the café sound scenes in the database audio. In some embodiments the default items are defined as combination of different contexts (for example audio, location, etc) at same time.

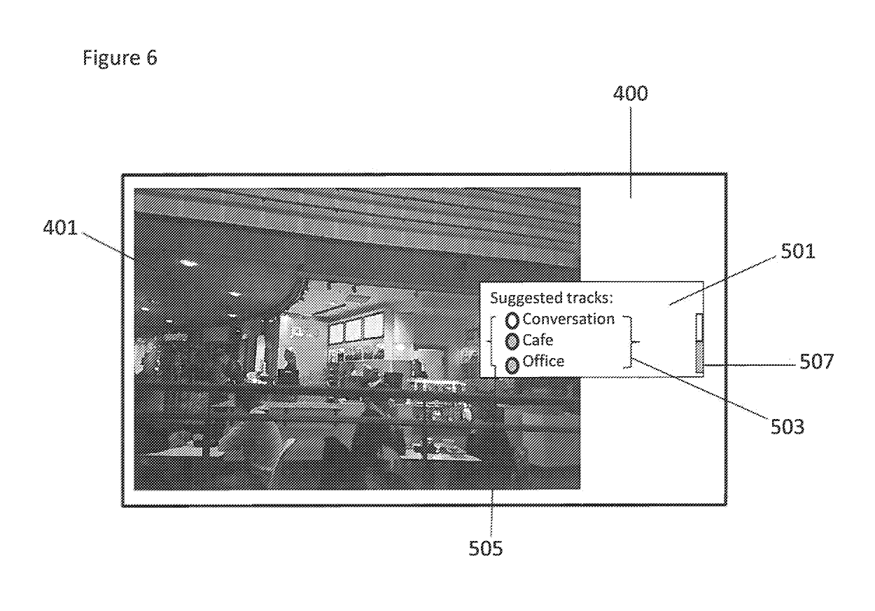

For example with respect to FIG. 6 a further example user interface display output 400 is shown with an ordered list suitable for implementing embodiments as described herein. The display can for example in some embodiments be configured to show the image output 401 from the camera, and also a text/selection box 501 within which is shown an ordered selection of the track suggestion list 503, a scroll bar 507 showing the position of the selection of the track suggestion list with respect to the full suggestion list and a selection radio button array 505 where at least one of the tracks are highlighted. In the example shown the audio context determiner 104 can have determined an audio context of ‘conversation’ and the audio track suggestion determiner 101 ordered the list of available tracks such that those the same as or similar are at the top of the list.

It would be understood that in some embodiments the audio track suggestion determiner 101 can be configured to display only the tracks with associated contexts which that match the determined audio context (or have associated contexts which are ‘similar’ to the determined audio context). In some embodiments the audio track suggestion determiner 101 can be configured to display the complete list but enable only the tracks with associated contexts which that match the determined audio context (or have associated contexts which are ‘similar’ to the determined audio context) to be selected. For example in some embodiments the radio buttons can be disabled or ‘greyed-out’ for the non-similar contexts. It would be understood that in some embodiments any suitable highlighting or selection of displayed tracks can be employed.

In some embodiments the audio track suggestion determiner 101 can be configured to select at least one of the suggested tracks.

The operation of selecting the track from the track suggestions is shown in FIG. 3 by step 210.

It would be understood that the selection of the audio track can be performed for example based on a matching or near matching criteria between the audio track associated context and the determined audio context of the environment.

In some embodiments the user can influence the selection. In some embodiments the audio track suggestion determiner 101 can be configured to receive a user interface input. For example as shown with respect to FIGS. 5 and 6 each of the available tracks have an associated radio button which can be selected by the user (by touching the display). The audio track suggestion determiner 101 can then select the tracks based on the user interface input (which in turn can be based on the determined audio context).

The operation of receiving a selection input from the display touch input is shown in FIG. 4 by step 305.

Furthermore the operation of selecting a track based on the selection input is shown in FIG. 4 by step 307.

In some embodiments it would be understood that the track selection can in some embodiments be the ‘live’ recorded audio track rather than the pre-recorded audio tracks. For example where there is no match or context similar track in the pre-recorded audio track database or library then the audio track suggestion determiner 101 can be configured to output the microphone signals or an edited version of the microphone signals. In some embodiments the microphone signals can themselves be a suggested audio track from which at least one track is selected.

The audio track can then be output to the mixer and synchroniser 109.

In some embodiments the example audio enhanced cinemagraph generator comprises a video/image analyser 103. The video/image analyser 103 can in some embodiments be configured to receive the images from the camera 51 and determine within the images animation objects which can be used in the cinemagraph. The analysis performed by the video/image analyser can be any suitable analysis. For example in some embodiments the differences between images or frames in the video within the position or interest regions are determined (in a manner similar to motion vector analysis in video coding).

The video/image analyser 103 can in some embodiments output these image results to the cinemagraph generator 105.

The operation of analysing the visual source directions corresponding to determine position of interest selection regions is shown in FIG. 3 by step 203.

In some embodiments the example audio enhanced cinemagraph generator comprises a cinemagraph generator 105. The cinemagraph generator 105 is configured to receive the images and video and any image/video motion selection data from the video/image analyser 103 and generate suitable cinemagraph data. In some embodiments the cinemagraph generator is configured to generate animated image data however as described herein in some embodiments the animation can be subtle or missing from the image (in other words the image is substantially a static image). The cinemagraph generator 105 can be any suitable cinemagraph or animated image generating means configured to generate data in a suitable format which enables the cinemagraph viewer to generate the image with any motion elements. The cinemagraph generator 105 can be configured in some embodiments to output the generated cinemagraph data to a mixer and synchroniser 109.

The operation of generating the animated image data is shown in FIG. 3 by step 205.

In some embodiments the apparatus comprises a mixer and synchroniser 109 configured to receive both the video images from the cinemagraph generator 105 and the audio signals from the audio track suggestion determiner 101 and configured to mix and synchronise signals in a suitable manner.

The mixer and synchroniser 109 can in some embodiments comprise a synchroniser or means to synchronise or associate the audio data with the video data. The synchroniser can be configured to synchronise the audio signal to the image and the image animation. For example the audio track can be synchronised at the start of an animation loop.

The synchroniser in some embodiments can be configured to output the synchronised audio and video data to a mixer.

In some embodiments the mixer and synchroniser can comprise a mixer. The mixer can be configured to mix or multiplex the data to form a cinemagraph or animated image metadata file comprising both image or video data and audio signal data. In some embodiments this mixing or multiplexing of data can generate a file comprising at least some of: video data, audio data, sub region identification data and time synchronisation data according to any suitable format. The mixer and synchroniser can in some embodiments output the metadata or file output data.

The operation of mixing and synchronizing the data is shown in FIG. 3 by step 211.

In some embodiments the mixer and synchronizer 109 can be configured to receive the microphone array 11 output as well as the output from the audio track suggestion determiner 101. In such embodiments rather than replacing the captured sound or audio from the microphones with the library audio track as selected by the audio track suggestion determiner a mix of the two can be used. For example in some embodiments the user could define a mix between these tracks. In some embodiments the apparatus can be configured to display on the display user interface a slider which has the following effects. When the slider is located at the left position only captured or recorded audio is used, when the slider is located at the right position only the library track is used and, when the slider is between the left and right positions a mix between the captured or recorded audio and the library track is used.

Thus for example a user can be configured to start a cinemagraph application and captures a video. While capturing video using the camera, the audio signal is captured using the microphone(s). It would be understood that in some circumstances the audio capture can start before the cinemagraph is composed. For example the audio capture or recording can started when the cinemagraph application is launched. Furthermore in some embodiments the audio recording or capture can continue while or after the video part of the cinemagraph has been composed. This for example can be employed such that there is enough audio signal available for context analysis.

As described herein automatic audio context recognition can be then employed for the audio signal (that is at least partly captured from the same time instant from which video for the cinemagraph is captured). The audio context determiner can then in some embodiments output a context estimate. The audio track suggestion determiner uses the detected context to filter (or generate) a subset from all potential audio tracks that exist in the audio track library. Alternatively as described herein a full list of audio tracks is provided, but order is changed so that first ones are the best matching ones. In some embodiments the subset is shown to the user as a list in the UI.

For example a user captures a cinemagraph in café. In this example the user implements the embodiments as described herein by selecting a ‘replace audio’ option or when they click a “replace audio from library” option. In such an example the application shows the user a list of tracks where contextually sorted are pre-recorded tracks with an associated context of “conversation”, “café” and “office” are the first items displayed. In such an example the user can select an item easily without browsing and searching the item from a long list.

In some embodiments the audio track suggestion determiner can know in advance all possible context types (from which the context recognizer or audio context determiner may detect). Audio tracks in the audio track database or library can as described herein be pre-classified or associated or tagged to these classes. In some embodiments the class or associated context info may be added as metadata to the audio track database or the audio track suggestion determiner can have separate mapping table and database to match detected context with the tracks in the database. In some embodiments the context info may include more detailed features that have been determined from the audio or other sensors. These features may be analyzed by the context recognizer and they may have been pre-analysed and stored as a metadata to each of the audio tracks in the database. Thus, the audio track suggestion determiner may use these features to find suggestions from the audio track database based on similarity between the features.

Although the embodiments described herein show the application of the method to cinemagraph or animated images it would be understood that the same or similar methods can be implemented to still images or as background tracks for video.

It shall be appreciated that the term user equipment is intended to cover any suitable type of wireless user equipment, such as mobile telephones, portable data processing devices or portable web browsers. Furthermore, it will be understood that the term acoustic sound channels is intended to cover sound outlets, channels and cavities, and that such sound channels may be formed integrally with the transducer, or as part of the mechanical integration of the transducer with the device.

In general, the design of various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The design of embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory used in the design of embodiments of the application may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be designed by various components such as integrated circuit modules.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-20. (canceled)

21. A method comprising:
receiving at least one audio signal and/or at least one sensor signal;
receiving at least one image frame;
determining at least one context based on the at least one audio signal and/or sensor signal;
determining at least one context audio signal based on the at least one context; and
associating the at least one context audio signal with the at least one image frame.

22. The method as claimed in claim 21, wherein receiving at least one sensor signal comprises at least one of:
receiving a humidity value from a humidity sensor;
receiving a temperature value from a thermometer sensor;
receiving a position estimate from a position estimating sensor;
receiving an orientation estimate from a compass;
receiving an illumination value from an illumination sensor;
receiving the at least one image frame from a camera sensor;
receiving an air pressure value from an air pressure sensor;
receiving the at least one sensor signal from a memory; and
receiving the at least one sensor signal from an external apparatus.

23. The method as claimed in claim 21, wherein determining at least one context audio signal associated with the at least one audio context comprises:
determining at least one library audio signal, wherein the at least one library audio signal comprises a context value; and
selecting the at least one context audio signal from the at least one library audio signal and the at least one audio signal.

24. The method as claimed in claim 23, wherein selecting the at least one context audio signal from the at least one library audio signal and the at least one audio signal comprises selecting the at least one context audio signal from the at least one library audio signal based on the context value similarity to the at least one context.

25. The method as claimed in claim 23, wherein selecting the at least one context audio signal from the at least one library audio signal based on the context value similarity to the at least one context determined by analysing the at least one audio signal comprises:
displaying the at least one library audio signal in an order based on the at least one library signal context value similarity to the at least one context; and
receiving at least one user interface selection from the displayed at least one library audio signal.

26. The method as claimed in claim 23, wherein determining at least one context audio signal associated with the at least one context further comprises mixing the at least one context audio signal from the selected at least one library audio signal and the at least one audio signal.

27. The method as claimed in claim 23, wherein determining at least one library audio signal comprising a context value comprises at least one of:
receiving at least one library audio signal from a memory audio track library; and
receiving at least one library audio signal from an external server audio track library.

28. The method as claimed in claim 21, further comprising generating at least one animated image from the at least one image frame and associating the at least one context audio with at least part of the at least one animated image.

29. The method as claimed in claim 21, wherein receiving at least one audio signal comprises at least one of:
receiving the at least one audio signal from at least one microphone;
receiving the at least one audio signal from a memory; and
receiving the at least one audio signal from an external apparatus.

30. The method as claimed in claim 21, wherein receiving the at least one image frame comprises:
receiving the at least one image frame from at least one camera;
receiving the at least one image frame from a memory;
receiving the at least one image frame from a video recording;
receiving the at least one image frame from a video file; and
receiving the at least one image frame from an external apparatus.

31. The method as claimed in claim 29, wherein the at least one microphone is configured to capture the at least one audio signal.

32. An apparatus comprising at least one processor and at least one memory including computer code for one or more programs, the at least one memory and the computer code configured to with the at least one processor cause the apparatus to at least:
receive at least one audio signal and/or at least one sensor signal;
receive at least one image frame;
determine at least one context based on the at least one audio signal and/or sensor signal;
determine at least one context audio signal based on the at least one context; and
associate the at least one context audio signal with the at least one image frame.

33. The apparatus as claimed in claim 32, wherein receiving at least one sensor signal causes the apparatus to perform at least one of:
receive a humidity value from a humidity sensor;
receive a temperature value from a thermometer sensor;
receive a position estimate from a position estimating sensor;
receive an orientation estimate from a compass;
receive an illumination value from an illumination sensor;
receive the at least one image frame from a camera sensor; and
receive an air pressure value from an air pressure sensor.

34. The apparatus as claimed in claim 32, wherein determining at least one context audio signal associated with the at least one audio context causes the apparatus to:
determine at least one library audio signal, wherein the at least one library audio signal comprises a context value; and
select the at least one context audio signal from the at least one library audio signal and the at least one audio signal.

35. The apparatus as claimed in claim 34, wherein selecting the at least one context audio signal from the at least one library audio signal and the at least one audio signal causes the apparatus to select the at least one context audio signal from the at least one library audio signal based on the context value similarity to the at least one context.

36. The apparatus as claimed in claim 34, wherein selecting the at least one context audio signal from the at least one library audio signal based on the context value similarity to the at least one context determined by analysing the at least one audio signal causes the apparatus to:
display the at least one library audio signal in an order based on the at least one library signal context value similarity to the at least one context; and
receiving at least one user interface selection from the displayed at least one library audio signal.

37. The apparatus as claimed in claim 34, wherein determining at least one context audio signal associated with the at least one context further causes the apparatus to mix the at least one context audio signal from the selected at least one library audio signal and the at least one audio signal.

38. The apparatus as claimed in claim 34, wherein determining at least one library audio signal comprising a context value causes the apparatus to:
receive at least one library audio signal from a memory audio track library; and
receive at least one library audio signal from an external server audio track library.

39. The apparatus as claimed in claim 32, further caused to generate at least one animated image from the at least one image frame and associate the at least one context audio with at least part of the at least one animated image.

40. An apparatus comprising:
an input configured to receive at least one audio signal and/or sensor signal;
an image input configured to receive at least one image frame;
a context determiner configured to determine at least one context based on the at least one audio signal and/or sensor signal;
an audio track suggestion determiner configured to determine at least one context audio signal based on the at least one context; and
a mixer configured to associate the at least one context audio signal with the at least one image frame.
